(19) United States
(12) Patent Application Publication
(10) Pub. No.: US 2016/0214363 A1
(43) Pub. Date: Jul. 28, 2016

(54) VACUUM THERMOCOMPRESSION APPARATUS

(71) Applicant: NIIGATA JAMCO CORPORATION, Murakami-shi (JP)

(72) Inventor: Norio OSHIMA, Murakami-shi (JP)

(73) Assignee: NIIGATA JAMCO CORPORATION, Murakami-shi (JP)

(21) Appl. No.: 14/744,122

(22) Filed: Jun. 19, 2015

(30) Foreign Application Priority Data
Jan. 23, 2015 (JP) 2015-011163

(51) Int. Cl. B32B 37/10; B32B 37/12; B32B 37/06

(52) U.S. Cl. CPC B32B 37/1018; B32B 37/06; B32B 37/1207; B32B 2037/1215; B32B 2255/10

(57) ABSTRACT

Provided is a vacuum thermocompression apparatus capable of efficiently heating a base material or the like. A vacuum thermocompression apparatus for causing a laminated member (2) laminated on a base material (1) with an adhesive material interposed therebetween to be subjected to thermocompression under a reduced-pressure atmosphere, wherein the vacuum thermocompression apparatus is characterized in comprising a placement part (4) on which the base material (1) having the laminated member (2) laminated thereon with the adhesive material interposed therebetween is placed, a cover body (6) for covering the base material (1) and the laminated member (2) placed on the placement part (4), and a sheet-shaped planar heating element (5) provided inside the cover body (6) and positioned to cover at least the upper surface of the base material (1) and the laminated member (2), the vacuum thermocompression apparatus being configured to heat the base material (1) and the laminated member (2) using the planar heating element (5) while reducing the pressure in the space enclosed by the cover body (6) and the placement part (4).

### TECHNICAL FIELD

The present invention relates to a vacuum thermocompression apparatus.

### BACKGROUND ART

Honeycomb sandwich panels, which are light-weight and exhibit exceptional strength against bending stress, shear stress, and other such forces, are currently used as structural materials in aircraft and the like. The honeycomb sandwich panel comprises a core having a honeycomb structure, and fiber-reinforced composite plate-shaped members laminated on both sides of the core and caused to adhere thereto, as disclosed in, e.g., patent document 1.

When a synthetic resin film or other surface material (e.g., wallpaper or the like when a honeycomb sandwich panel is to be used as an interior material) is attached to the surface of the honeycomb sandwich panel described above, this surface material is attached using a vacuum thermocompression apparatus called a “heat vacuum applicator.”

Conventional heat vacuum applicators comprise a placement device on which a panel and a surface material are placed, and an opening/closing lid that opens/closes with respect to the placement device; these apparatuses operate such that a panel is placed on the placement device, a surface material having an adhesive provided thereto is laminated and placed on the panel, the panel and the surface material are covered by a silicon rubber cover, the opening/closing lid is closed, the gap between the placement device and the silicon rubber cover is heated by a plurality of infrared lamps disposed above the silicon rubber cover (on the ceiling part of the closed lid) while being reduced in pressure, and the panel and the surface material are attached to each other. However, further enhancements to heat vacuum applicator technology are in demand.

### PRIOR ART DOCUMENTS

### Patent Documents

[Patent Document 1] JP-A 2006-2869

### DISCLOSURE OF THE INVENTION

### Problems to be Solved by the Invention

In view of the current state as described above, the present invention provides a vacuum thermocompression apparatus having exceptional utility, the vacuum thermocompression apparatus making it possible to uniformly heat a base material or the like using a planar heating element, and moreover to efficiently heat the base material or the like due to the planar heating element being provided not on the outer side of a cover body but rather on the inner side thereof, as well as to perform other such tasks.

### Means for Solving the Problems

The main points of the present invention are described below with reference to the attached drawings.

The present invention relates to a vacuum thermocompression apparatus for causing a laminated member 2 laminated on a base material 1 with an adhesive material interposed therebetween to be subjected to thermocompression under a reduced-pressure atmosphere, wherein the vacuum thermocompression apparatus is characterized in comprising a placement part 4 on which the base material 1 having the laminated member 2 laminated thereon with the adhesive material interposed therebetween is placed, a cover body 6 for covering the base material 1 and the laminated member 2 placed on the placement part 4, and a planar heating element 5 provided inside the cover body 6 and positioned to cover at least the upper surface of the base material 1 and the laminated member 2, the vacuum thermocompression apparatus being configured to heat the base material 1 and the laminated member 2 using the planar heating element 5 while reducing the pressure in the space enclosed by the cover body 6 and the placement part 4.

The present invention further relates to a vacuum thermocompression apparatus according to the first aspect, wherein the vacuum thermocompression apparatus is characterized in that the planar heating element 5 is formed by embedding a heating member into a flexible sheet body, the planar heating element 5 being firmly attached to a surface covered thereby when the pressure in the space enclosed by the cover body 6 and the placement part 4 is reduced.

The present invention further relates to a vacuum thermocompression apparatus according to the second aspect, wherein the vacuum thermocompression apparatus is characterized in that the planar heating element 5 is a silicon rubber heater.

The present invention further relates to a vacuum thermocompression apparatus according to the first aspect, wherein the vacuum thermocompression apparatus is characterized in that the planar heating element 5 is a plurality of planar heating elements divided into prescribed regions, a temperature-controlling mechanism being provided for controlling the temperature of each of the divided planar heating elements 5 independently.

The present invention further relates to a vacuum thermocompression apparatus according to the first aspect, wherein the vacuum thermocompression apparatus is characterized in that a sheet-shaped weight 7 is provided inside the cover body 6.

The present invention further relates to a vacuum thermocompression apparatus according to the first aspect, wherein the vacuum thermocompression apparatus is characterized in that an accommodating part 10 having an outward-pulled body 9 capable of being pulled outward is provided at each of a plurality of levels along a vertical direction to a base body 8, the placement part 4 being provided to the outward-pulled body 9.

The present invention further relates to a vacuum thermocompression apparatus according to the sixth aspect, wherein the vacuum thermocompression apparatus is characterized in that the cover body 6 and the planar heating element 5 are provided on the top surface of the accommodating part 10 of the base body 8, the placement part 4 on which the base material 1 having the laminated member 2 laminated thereon with the adhesive material interposed therebetween is placed being provided to the outward-pulled body 9, and an elevating mechanism for causing the cover body 6 and the planar heating element 5 to descend over the placement part 4 when the outward-pulled body 9 is accommodated in the accommodating part 10 being provided to the vacuum thermocompression apparatus.

The present invention further relates to a vacuum thermocompression apparatus according to the first aspect, wherein the vacuum thermocompression apparatus is characterized in that the base material 1 is a honeycomb sandwich panel, the adhesive material is a hot-melt adhesive, and the laminated member 2 is a synthetic resin film.

### Effect of the Invention

Because the present invention is configured as described above, it is possible to provide a vacuum thermocompression apparatus having exceptional utility, the vacuum thermocompression apparatus making it possible to uniformly heat a base material or the like using a planar heating element, and moreover to efficiently heat the base material or the like due to the planar heating element being provided not on the outer side of a cover body but rather on the inner side thereof, as well as to perform other such tasks.

### BRIEF DESCRIPTION OF THE DRAWINGS

FIG. 1 is a schematic perspective view of the present example;

FIG. 2 is an enlarged schematic cross-sectional view of the main section of the present example; and

FIG. 3 is a schematic plan view of a planar heating element of the present example.

### BEST MODE FOR CARRYING OUT THE INVENTION

A preferred example of the present invention is briefly described below with reference to the drawings while indicating the effects of the present invention.

A base material 1 having a laminated member 2 laminated thereon with an adhesive material interposed therebetween is placed on a placement part 4, the base material 1 and the laminated member 2 are covered by a cover body 6, and the base material 1 and the laminated member 2 are heated by a planar heating element 5 provided on the inner side of the cover body 6 while the pressure in the space enclosed by the cover body 6 and the placement part 4 is reduced.

At this time, because it is possible to heat the base material 1 or the like using the planar heating element 5 provided on the inner side of the cover body 6 under a reduced-pressure atmosphere, the base material 1 or the like can be uniformly heated by the planar heating element 5, as will be apparent, and the heating of the base material 1 or the like can be performed more efficiently than when heating is performed from outside the cover body 6.

Furthermore, the planar heating element 5 is used rather than a conventional infrared lamp, whereby the apparatus configuration can be reduced in size (thickness); it is possible to, e.g., configure the apparatus such that an accommodating part 10 having an outward-pulled body 9 capable of being pulled outward is provided at each of a plurality of levels along a vertical direction to a base body 8, and the placement part 4 is provided to the outward-pulled body 9; and it is possible to save space.

### EXAMPLES

A specific example of the present invention is described below with reference to the diagrams.

The present example is a vacuum thermocompression apparatus for causing a laminated member 2 laminated on a base material 1 with an adhesive material interposed therebetween to be subjected to thermocompression under a reduced-pressure atmosphere, wherein the vacuum thermocompression apparatus comprises a placement part 4 on which the base material 1 and the laminated member 2 laminated on the base material 1 with the adhesive material interposed therebetween are placed, a cover body 6 for covering the base material 1 and the laminated member 2 placed on the placement part 4, and a planar heating element 5 provided between the cover body 6 and the base material 1 and laminated member 2 so as to cover at least the upper surface of the base material 1 and the laminated member 2, the vacuum thermocompression apparatus being configured to heat the base material 1 and the laminated member 2 using the planar heating element 5 while reducing the pressure in the space enclosed by the cover body 6 and the placement part 4.

Specifically, a synthetic resin film (e.g., a polyethylene film) to be used as the laminated member 2 is laminated on a honeycomb sandwich panel to be used as the base material 1 with a hot-melt adhesive (e.g., a polyurethane hot-melt adhesive) to be used as the adhesive layer interposed therebetween, and the synthetic resin film and honeycomb sandwich panel are subjected to thermocompression. The adhesive is provided to the surface of the laminated member 2 that faces the base material 1.

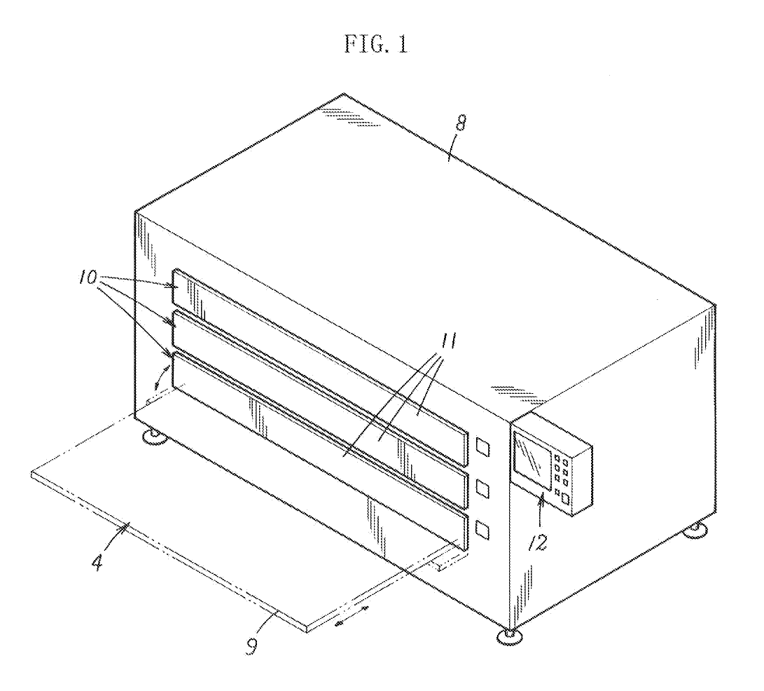

In the present example, as shown in FIG. 1, an accommodating part 10 having an outward-pulled body 9 (table) capable of being pulled outward is provided at each of a plurality of levels (three in the present example) along a vertical direction to a base body 8, and the placement part 4 is provided to the outward-pulled body (the placement part 4 is the upper surface of the outward-pulled body 9). Therefore, it is possible to perform processes in parallel using a single apparatus, and thermocompression can be performed even more efficiently. In the drawing, 11 indicates an opening/closing lid, and 12 indicates a control panel.

The cover body 6 and the planar heating element 5 are provided on the top surface of the accommodating part 10 of the base body 8. An elevating mechanism is provided to the base body 8, the elevating mechanism causing the cover body 6 and the planar heating element 5 to descend over the base material 1 and the laminated member 2 when the outward-pulled body 9, having the base material 1 and the laminated member 2 placed on the placement part 4, is accommodated in the accommodating part 10.

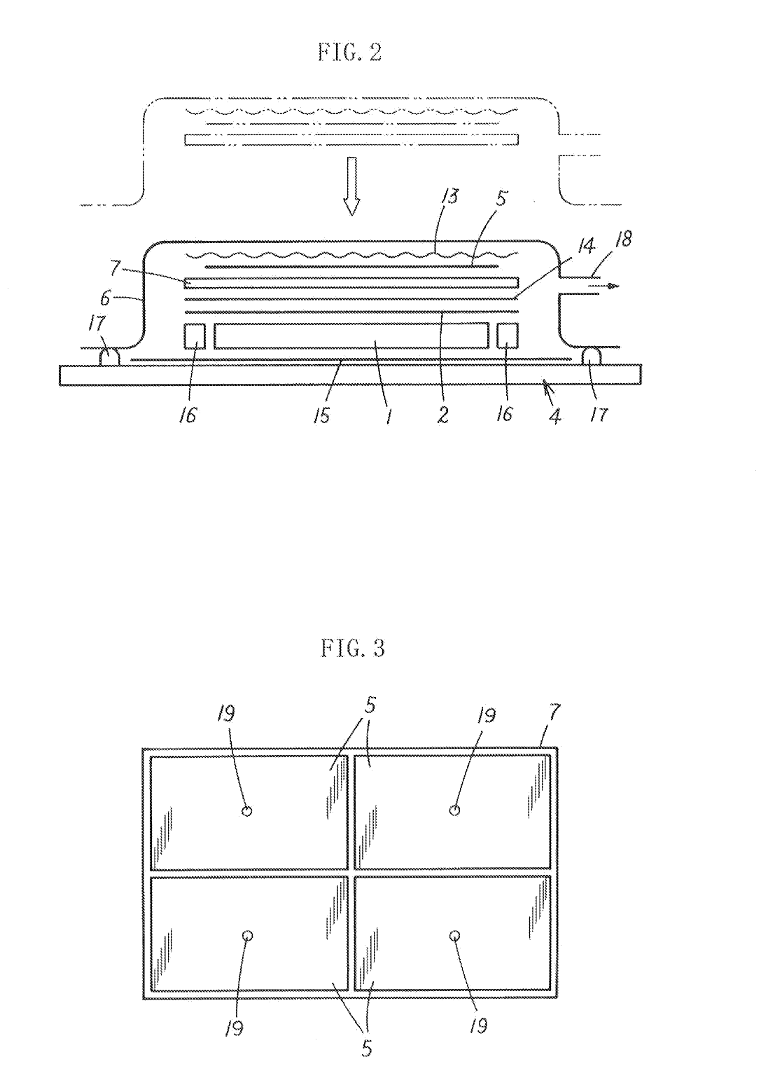

Specifically, the cover plate 6, a heat-retaining mat 13 (airweave), the planar heating element 5, and a metal pressure plate to be used as a weight 7 are provided to the top-surface side of the accommodating part 10, as shown in FIG. 2; these components can be caused by the elevating mechanism to integrally descend so as to cover the base material 1 and the laminated member 2 on the placement part 4. In the drawing, 14 indicates a non-woven fabric for smoothing the flow of air.

The placement part 4 is the flat surface on the upper surface of the outward-pulled body 9, and has a bleeder cloth 15 for smoothing the flow of air laid thereon, the base material 1 and the laminated member 2 being placed on the bleeder cloth 15. Spacers 16 are provided outward from the base material 1. Mound-shaped vacuum seal members 17 are provided so as to enclose the outer region of the placement area. A configuration may be adopted in which another bleeder cloth is provided between the cover body 6 and the top surface of the accommodating part 10.

The outer peripheral parts of the cover body 6 (vacuum bag) descending over the placement part 4 come in contact with the vacuum seal members 17, and air is discharged from an air discharge hole 18 of the cover body 6 by a vacuum pump or other device, whereby the pressure in the space enclosed by the cover body 6, the placement part 4, and the vacuum seal members 17 can be reduced.

The planar heating element 5 is a silicon rubber heater formed by embedding a heating member into a flexible silicon rubber sheet. The silicon rubber heater is configured such that the planar heating element 5 is firmly attached to a surface (in the present example, the upper surface of the weight 7) covered thereby when the pressure in the space enclosed by the cover body 6 and the placement part 4 is reduced.

In the present invention, the planar heating element 5 is a plurality of planar heating elements 5 divided into prescribed regions, a temperature-controlling mechanism being provided for controlling the temperature of each of the divided planar heating elements 5 independently. Specifically, four rectangular planar heating elements 5 are arranged in parallel, and are provided within an area that covers a prescribed area on the upper surface of the laminated member 2 (weight 7) laminated on the base material 1. A configuration may be adopted in which the planar heating elements are provided within an area covering the entire upper surface, or an area covering as far as the side surfaces of the base material 1. Providing a plurality of planar heating elements makes it possible to more finely adjust the temperature and facilitates maintenance. The temperature-controlling mechanism adjusts the degree of heating by the heating members in each of the planar heating elements so as to appropriately set the temperature in accordance with the temperatures measured by temperature sensors (thermocouples) provided to each of the planar heating elements 5.

The weight 7 is provided between the cover body 6 and the base material 1 and laminated member 2, and has a sheet shape extending so as to cover at least the entire surface of the laminated member 2. Therefore, the adhesive material melts while the laminated member 2 and the base material 1 are in a satisfactorily firmly attached state, and the laminated member 2 and the base material 1 become more strongly attached. The weight 7 (which is wider than the planar heating element 5) is firmly attached to the planar heating element 5 and heated, whereby the base material 1, the laminated member 2, and the adhesive material are more uniformly heated.

In the present example, a configuration is adopted in which a blower is provided to the accommodating parts 10, and, after the temperature is increased and maintained in a prescribed pattern in accordance with a prescribed program, the temperature is automatically decreased using the blower (and air (instrument air) in the worksite). Therefore, workability is significantly improved to a greater extent than in the prior art, in which a fan is manually set to decrease the temperature after the temperature is increased and maintained.

A vacuum thermocompression apparatus configured as described above is used to cause a base material 1 and a laminated member 2 to be attached using the steps described below.

(1) An opening/closing lid 11 of an accommodating part 10 of a base body 8 is opened, an outward-pulled body 9 is pulled outward, a base material 1 and a laminated member 2 are placed in a layered state on a placement part 4, and a non-woven fabric 14 is placed on the laminated member 2.

(2) When the outward-pulled body 9 is accommodated in the accommodating part 10, the opening/closing lid 11 is closed, and a start switch on a control panel 12 is pressed, a cover body 6, a gas-venting mat 13, a planar heating element 5, and a weight 7 are caused to descend.

(3) Interior air is discharged from an air discharge hole 18 of the cover body 6 to reduce the pressure in the space enclosed by the cover body 6, the placement part 4, and vacuum seal members 17, and the base material 1, etc., is heated in a prescribed pattern by the planar heating element 5, causing an adhesive material to melt and causing the base material 1 and the laminated member 2 to adhere to each other.

(4) When heating (temperature increase, temperature maintenance, and temperature decrease) is complete, the cover body 6, the gas-venting mat 13, the planar heating element 5, and the weight 7 are caused to ascend.

(5) The opening/closing lid 11 is opened, the outward-pulled body 9 is pulled outward, and the non-woven fabric 14 is removed.

The steps described above make it possible to obtain a product in which the base material 1 (honeycomb sandwich panel) and the laminated member 2 (polyethylene film) are attached to each other.

Because the present example is configured as described above, it is possible to heat a base material 1 or the like using a planar heating element 5 provided on the inner side of a cover body 6 under a reduced-pressure atmosphere when the base material 1 and a laminated member 2 are placed on a placement part 4, the base material 1 and the laminated member 2 are covered by the cover body 6, and the base material 1 and the laminated member 2 are heated by the planar heating element 5 while the pressure in the space enclosed by the cover body 6 and the placement part 4 is reduced; therefore, the base material 1 or the like can be uniformly heated by the planar heating element 5, as is apparent, and the heating of the base material 1 or the like can be performed more efficiently than when heating is performed from outside the cover body 6.

Furthermore, the planar heating element 5 is used rather than a conventional infrared lamp, whereby the apparatus configuration can be reduced in size (thickness); it is possible to, e.g., configure the apparatus such that an accommodating part 10 having an outward-pulled body 9 capable of being pulled outward is provided at each of a plurality of levels along a vertical direction to a base body 8, and the placement part 4 is provided to the outward-pulled body 9; and it is possible to save space.

Accordingly, the present example makes it possible to uniformly heat a base material or the like using a planar heating element, and moreover to efficiently heat the base material or the like due to the planar heating element being provided not on the outer side of a cover body but rather on the inner side thereof, as well as to perform other such tasks.

1. A vacuum thermocompression apparatus for causing a laminated member laminated on a base material with an adhesive material interposed therebetween to be subjected to thermocompression under a reduced-pressure atmosphere, wherein the vacuum thermocompression apparatus is characterized in comprising a placement part on which the base material having the laminated member laminated thereon with the adhesive material interposed therebetween is placed, a cover body for covering the base material and the laminated member placed on the placement part, and a planar heating element provided inside the cover body and positioned to cover at least the upper surface of the base material and the laminated member, the vacuum thermocompression apparatus being configured to heat the base material and the laminated member using the planar heating element while reducing the pressure in the space enclosed by the cover body and the placement part.

2. The vacuum thermocompression apparatus of claim 1, wherein the vacuum thermocompression apparatus is characterized in that the planar heating element is formed by embedding a heating member into a flexible sheet body, the planar heating element being firmly attached to a surface covered thereby when the pressure in the space enclosed by the cover body and the placement part is reduced.

3. The vacuum thermocompression apparatus of claim 2, wherein the vacuum thermocompression apparatus is characterized in that the planar heating element is a silicon rubber heater.

4. The vacuum thermocompression apparatus of claim 1, wherein the vacuum thermocompression apparatus is characterized in that the planar heating element is a plurality of planar heating elements divided into prescribed regions, a temperature-controlling mechanism being provided for controlling the temperature of each of the divided planar heating elements independently.

5. The vacuum thermocompression apparatus of claim 1, wherein the vacuum thermocompression apparatus is characterized in that a sheet-shaped weight is provided inside the cover body.

6. The vacuum thermocompression apparatus of claim 1, wherein the vacuum thermocompression apparatus is characterized in that an accommodating part having an outward-pulled body capable of being pulled outward is provided at each of a plurality of levels along a vertical direction to a base body, the placement part being provided to the outward-pulled body.

7. The vacuum thermocompression apparatus of claim 6, wherein the vacuum thermocompression apparatus is characterized in that the cover body and the planar heating element are provided on the top surface of the accommodating part of the base body, the placement part on which the base material having the laminated member laminated thereon with the adhesive material interposed therebetween is placed being provided to the outward-pulled body, and an elevating mechanism for causing the cover body and the planar heating element to descend over the placement part when the outward-pulled body is accommodated in the accommodating part being provided to the vacuum thermocompression apparatus.

8. The vacuum thermocompression apparatus of claim 1, wherein the vacuum thermocompression apparatus is characterized in that the base material is a honeycomb sandwich panel, the adhesive material is a hot-melt adhesive, and the laminated member is a synthetic resin film.
